(19) United States
(12) Patent Application Publication
(10) Pub. No.: US 2004/0014580 A1
(43) Pub. Date: Jan. 22, 2004

(54) Apparatus for folding printed paper sections

(76) Inventors: Mitsuo Kitai, Kanagawa (JP); Takashi Iijima, Kanagawa (JP); Takanobu Sakakura, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/407,275

(22) Filed: Apr. 7, 2003

(30) Foreign Application Priority Data
Jul. 16, 2002 (JP) 2002-206650

(51) Int. Cl. B31F 1/00

(52) U.S. Cl. 493/432

(57) ABSTRACT

A printed paper web is cut into sections by a cutting cylinder while traveling on a folding cylinder, and each paper section has its midpart subsequently pushed off the folding cylinder into a jaw cavity in a jaw cylinder thereby to be folded into a signature. The jaw cavity has mounted therein a series of spaced-apart movable jaw parts jointly movable into and out of paper section-folding engagement with a series of spaced-apart fixed jaw parts. The folding cylinder has a retractable folding blade mounted thereto for pushing each paper section into space between the series of fixed and movable jaw parts. Fabricated from sheet metal, the folding blade has a series of discrete folding blade parts each having a portion that is situated out of register with both of the fixed and the movable jaw parts or with the image area of the paper section and which is thicker than the rest of the folding blade part.

### BACKGROUND OF THE INVENTION

1. Field of the Invention

This invention relates to a folding device built into or appended to a web-fed printing press, as in newspaper production, for cutting the printed paper web or webs into sections, and folding the successive paper sections across the middle into the form of signatures. More particularly, the invention deals, the folding device of the rotary printing press, with the combination of a folding cylinder and jaw cylinder, the latter cylinder having sets of fixed and movable jaws arranged at circumferential spacings thereon for folding the paper sections as they are thrust into the jaw cavities by folding blades on the folding cylinder. Still more particularly, the invention pertains to the improved configuration of each folding blade designed to preclude ink transfer between the contacting surfaces of each paper section being folded.

2. Description of the Prior Art

The folding device has a cutting cylinder in addition to the folding cylinder and jaw cylinder, all in constant rotation at the same circumferential velocity during the progress of printing. The printed paper web or webs are first wrapped around part of the folding cylinder and, while traveling thereover, cut into successive sections by cutting blades on the cutting cylinder which is held against the folding cylinder via the web or webs. The folding cylinder is equipped with elongate folding blades each extending parallel to the folding cylinder axis and arranged at circumferential spacings thereon. Each folding blade is movable radially of the folding cylinder for pushing the paper section into one of the elongate jaw cavities which are cut in the surface of the jaw cylinder at constant circumferential spacings.

Pushed off the surface of the folding cylinder by one of the folding blades, the paper section has its midpart placed between the fixed and movable jaws in the jaw cavity. The midpart of the paper section is then captured, together with the folding blade, between the fixed and movable jaws as the movable jaw is closed against the fixed jaw, and thereby folded along the centerline of the paper section. The paper section is subsequently carried away from the surface of the folding cylinder by the jaw cylinder as these cylinders continue rotation in opposite directions. The folding blade withdraws from between the folds of the midpart of the paper section, leaving the same sandwiched between the fixed and movable jaws thereby to be folded. The folding blade acts, during its withdrawal, as if prying open the jaws. The paper section is subsequently folded along the centerline while being carried away from the folding cylinder.

Difficulties have been encountered in folding as above the paper sections, which are literally fresh from the press, without causing ink offset between their contacting surfaces and without physically ruining them. A primary reason for such difficulties is that in practice, the paper sections are subject to substantive change in thickness even in the limited case of newspaper production. The paper itself to be printed can come in different thicknesses. What is more, the pages of each signature to be produced can vary considerably in number as two or more webs are concurrently printed by separate printing units of the press and superposed one upon another before being fed into the folding device for production of multiple-page signatures. The spacing between each set of fixed and movable jaws must be adjustable to such widely different thicknesses of the paper sections to be folded, in order to create proper fold without doing no harm to the printed paper. Usually, the movable jaws are sprung to capture the paper sections of various thicknesses firmly enough to avert accidental disengagement as the paper sections are subsequently folded into signatures.

As heretofore constructed, however, the folding jaw devices tended to cause ink offset between the contacting surfaces of the paper sections, particularly during the withdrawal of the folding blade from between the fixed and movable jaws. This is because the folding blade rubs hard against the paper sections as it withdraws from between the jaws by the rotation of the jaw cylinder and folding cylinder in opposite directions. The ink offset must be avoided by any means as it represents a serious impairment of the printing quality and a degradation of the commercial values of the newspapers.

Japanese Unexamined Utility Model Publication No. 60-193365 is typical of devices conventionally suggested to avoid ink transfer between the surfaces of paper sections being folded. It teaches use of spring-loaded pins extending through each of the movable jaws on the jaw cylinder to press the inserted midpart of the paper section against abutments of polyurethane or like elastic material affixed to parts of the surface of the fixed jaw. The folding blades on the folding cylinder are each recessed in parts to permit the pins to push the paper section against the elastic abutments. The movable jaw is itself spring-biased to urge the folded midpart of the paper section against the bare surface of the fixed jaw upon withdrawal of the folding blade from between the folds of the paper section midpart.

An objection to this prior art device is that the folding blade, which must be thick enough to posses the required mechanical strength, is initially wholly caught between the fixed and movable jaws together with the folded midpart of the paper section. The movable jaw is urged against the fixed jaw via the paper section to an extent necessary to engage the paper section against accidental disengagement even after the withdrawal of the folding blade. As a result, the engagement of not only the folded midpart of the section but the folding blade, too, between these jaws could be a cause for ink offset between the contacting surfaces of the paper section.

It might be argued that the paper section could be caught somewhat loosely between the jaws if it were engaged, instead, between the spring-loaded pins and the elastic abutments firmly enough to prevent accidental disengagement. But then ink offset would become even easier to occur at those parts of the paper section which were pressed by the pins against the abutments. Furthermore, while being caught between these parts, the paper section was liable to have its exposed surfaces smeared by the ink because of the frictional resistance of the polyurethane abutments. The pins are themselves objectionable as they are left protruding from the surface of the movable jaw toward the abutments under spring pressure even when the paper is not inserted. The paper sections were easy to be torn, wrinkled or otherwise impaired by hitting the pins on insertion in the jaw cavities.

A different approach to the problem is found in Japanese Patent Publication No. 7-55761, which provides for adjustment of the minimum spacing between the fixed and movable jaws to the thickness of the paper sections to be folded. But the fact remains that the folding blade is wholly caught between the fixed and movable jaws together with each paper section. The paper section is therefore pressed harder while being caught together with the folding blade between the jaws than is needed for folding without disengagement.

### SUMMARY OF THE INVENTION

The present invention seeks to keep the paper sections from being smeared by ink offset, from being torn, wrinkled or otherwise damaged, or from being accidentally disengaged from between the jaws, while being folded into signatures by folding devices of the kind defined.

Stated briefly, the invention concerns a folding device to be appended to a web-fed printing press, wherein a printed paper web is cut into sections by a cutting cylinder while traveling on a folding cylinder, wherein each paper section has its midpart subsequently pushed off the folding cylinder into a jaw cavity in a jaw cylinder, and wherein each paper section is subsequently carried away from the folding cylinder onto the jaw cylinder to be folded into a signature.

More particularly, the invention provides the improvement combination of a fixed jaw immovably mounted in the jaw cavity in the jaw cylinder, a movable jaw mounted in the jaw cavity in the jaw cylinder for movement relative to the jaw cylinder toward and away from the fixed jaw in order to engage and fold each paper section as its midpart is inserted in the jaw cavity, and a folding blade mounted to the folding cylinder for pushing the midpart of each paper section into the space between the fixed and the movable jaw in the jaw cavity in the jaw cylinder. At least either of the fixed and the movable jaw is divided into a series of spaced-apart jaw parts. The folding blade has portions that are thicker than the rest of the folding blade and which are out of register with at least either of the image area of each paper section being pushed into the jaw cavity and said at least either of the fixed and the movable jaw.

In the preferred embodiment to be disclosed subsequently, both fixed jaw and movable jaw have each a series of spaced-apart jaw parts, with each fixed jaw part opposed to one movable jaw part circumferentially of the jaw cylinder. The folding blade has itself also a series of spaced-apart folding blade parts comprised of a plurality of medial folding blade parts positioned in register with the image area of the paper section, and a pair of outmost folding blade parts lying outwardly of the medial folding blade parts. Each medial folding blade part has at least one portion which is thicker than the rest of the medial folding blade part and which is out of register with both of the fixed and the movable jaw parts. Each outmost folding blade part, on the other hand, has each a portion that is thicker than the rest of the outmost folding blade part and which is in register with one side margin of the paper section but totally out of register with its image area.

Thus, when each paper section on the folding cylinder has its midpart pushed by the improved folding blade into one jaw cavity in the jaw cylinder and therein pressed by the series of spaced-apart movable jaw parts against the associated series of spaced-apart fixed jaw parts, only the thin portions of the medial folding blade parts are caught between the fixed and the movable jaw parts. Although the pair of outmost folding blade parts have not only their thin portions, but their thick portions too, caught between the fixed and the movable jaw parts, this thick portions are out of register with the image area of the paper section. The thin portions of the folding blade parts will make the pressures acting on the image area of the paper section just a little bit higher than after the subsequent withdrawal of the folding blade from between the folds of the paper section. No ink offset is therefore to occur between the contacting surfaces of the paper section.

After the withdrawal of the folding blade, too, the pressures exerted upon the paper section by the movable jaw will not lessen so much as to allow the paper section to come off the jaws. The thick portions of the folding blade parts have proved effective to prevent them from deformation or breakage during insertion in the jaw cavity.

As an additional advantage, the working surfaces of both fixed and movable jaw parts can all be aligned parallel to the axis of jaw cylinder, without need for provision of spikes or other protuberances for engaging the paper sections. This fact, combined with the thinness of those portions of the folding blade parts which are caught between the fixed and movable jaw parts, makes it possible to create straight, neat folds on the paper sections and hence to produce signatures that are aesthetically favorable.

The above and other objects, features and advantages of this invention will become more apparent, and the invention itself will best be understood, from a study of the following description and appended claims, with reference had to the attached drawings showing the preferred embodiment of the invention.

### BRIEF DESCRIPTION OF THE DRAWINGS

FIG. 1 is a diagrammatic illustration of a folding station of a web-fed printing press including a folding cylinder and jaw cylinder to which is applicable the present invention;

FIG. 2 is an enlarged, fragmentary, developed sectional view, with parts shown broken away to reveal other parts, of the jaw cylinder of FIG. 1, showing in particular one series of fixed jaw parts and one series of movable jaw parts together with means for acting the movable jaw parts toward and away form the fixed jaw parts;

FIG. 3 is a fragmentary end view, with parts shown broken away to reveal other parts, of the jaw cylinder as seen in the direction of the arrow III in FIG. 2;

FIG. 4 is a still more enlarged sectional view taken along the line IV-IV in FIG. 2 and showing in particular one fixed jaw part and one movable jaw part together with some of the means for actuating the movable jaw part toward and away from the fixed jaw part;

FIG. 5 is a view similar to FIG. 4 except that a paper section is shown being inserted between the fixed and the movable jaw part by a thin portion of the folding blade;

FIG. 6 is also a view similar to FIG. 4 except that a paper section is shown being inserted between the fixed and the movable jaw part by a thick portion of the folding blade;

FIG. 7 is a view of explanatory nature showing the positional relationship among one series of fixed jaw parts, one series of movable jaw parts, and one series of folding blade parts, together with one paper section to be folded; and

FIG. 8 is an elevational view of the folding blade taken along the line VIII-VIII in FIG. 7.

### DESCRIPTION OF THE PREFERRED EMBODIMENT

Folding Station

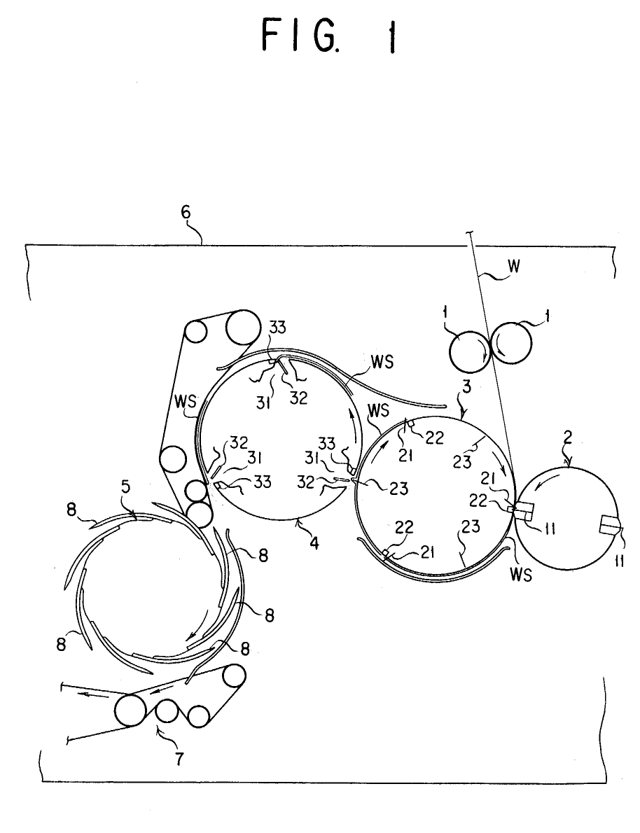

The present invention is currently considered best applicable to the folding station of a rotary printing press that incorporates two or more printing units for concurrently printing as many webs of paper which are to be jointly cut and folded into multiple-page signatures at one and the same folding station. It is understood, however, that only one of the printing units may be used for printing one web of paper. As illustrated diagrammatically in FIG. 1, the exemplified folding station has a pair of feed rollers 1 for frictionally introducing a web or webs W of printed paper into the folding station. Although in practice a plurality of webs may be concurrently printed as aforesaid and introduced in superposition into the folding station, it is assumed for simplicity of description that only one ing station, it is assumed for simplicity of description that only one printed web W is now being printed and fed into the folding station. The usual practice in the art is to fold the printed web longitudinally as by a former, not shown, which is positioned immediately upstream of the folding station.

The folding station has a cutting cylinder 2, a folding cylinder 3, a jaw cylinder 4, and a delivery fan 5, for cutting the printed web W into sections WS, folding each paper section across the middle into a signature, and delivering the successive signatures. All the listed cylinders 2-4 and the fan 5 are rotatably mounted between a pair of confronting framing walls 6, one shown. A delivery conveyor system 7 underlies the fan 5.

The cutting cylinder 2 has one or more, two shown, cutting blades 11 in circumferentially spaced-apart positions thereon, with each blade extending parallel to the cutting cylinder axis. The folding cylinder 3 has a plurality of, three in this embodiment, anvils or beds 22 at constant circumferential spacings on its surface for successive mating engagement with the cutting blades 11 on the cutting cylinder 2. Rows of retractable piercing pins 21 are also mounted to the surface of the folding cylinder 3, in positions immediately upstream of the anvils 22 with respect to the arrow-marked direction of rotation of the folding cylinder. Wrapped around part of the folding cylinder 3, the web W will be engaged by the successive rows of piercing pins 21 and cut transversely into sections WS as the two cutting blades 11 on the cutting cylinder 2 alternately engage with the successive anvils 22 on the folding cylinder 3. The paper sections WS will then ride on the folding cylinder 3 with their leading edges held engaged by the piercing pins 21.

The jaw cylinder 4, which is shown to be of the same diameter as the folding cylinder 3, has defined in its surface a plurality of, three in this embodiment, jaw cavities 31 at constant circumferential spacings. Carried by the folding cylinder 3 to a position opposite one of the jaw cavities 31 in the jaw cylinder 4, the paper section WS will have its midpart pushed by one of folding blades 23 on the folding cylinder 3 off its surface into one of the jaw cavities 31 in the jaw cylinder 4. The inserted midpart of the paper section WS is therein to be engaged by one set of fixed and movable jaws 32 and 33 to be set forth in detail subsequently. Concurrently, each paper section WS will have its leading edge released from the piercing pins 21 as the latter then retract into the folding cylinder 3.

The folding blade 23 will be subsequently withdrawn into the folding cylinder 3 out of engagement with the jaws 32 and 33, leaving behind the paper section WS captured by the jaws 32 and 33 thereby to be folded. As the folding cylinder 3 and jaw cylinder 4 continue rotation in opposite directions, the paper section WS will transfer from folding cylinder onto jaw cylinder and, by so doing, be folded along the centerline.

Positioned between jaw cylinder 4 and delivery conveyor system 7, the delivery fan 5 has a plurality of vanes 8 mounted slantingly on its surface at circumferential spacings to define pockets for receiving the folded paper sections or signatures WS. The signatures are to drop successively by gravity from the jaw cylinder 4 into these pockets on the delivery fan 5 and thence onto the delivery conveyor system 7.

The construction of the folding station as so far described is largely conventional, and therein lies no feature of the instant invention. The novel features of the invention will appear in the course of the following detailed description of the jaw cylinder 4, jaws 32 and 33 together with their drive means, and folding blades 23.

Jaw Cylinder

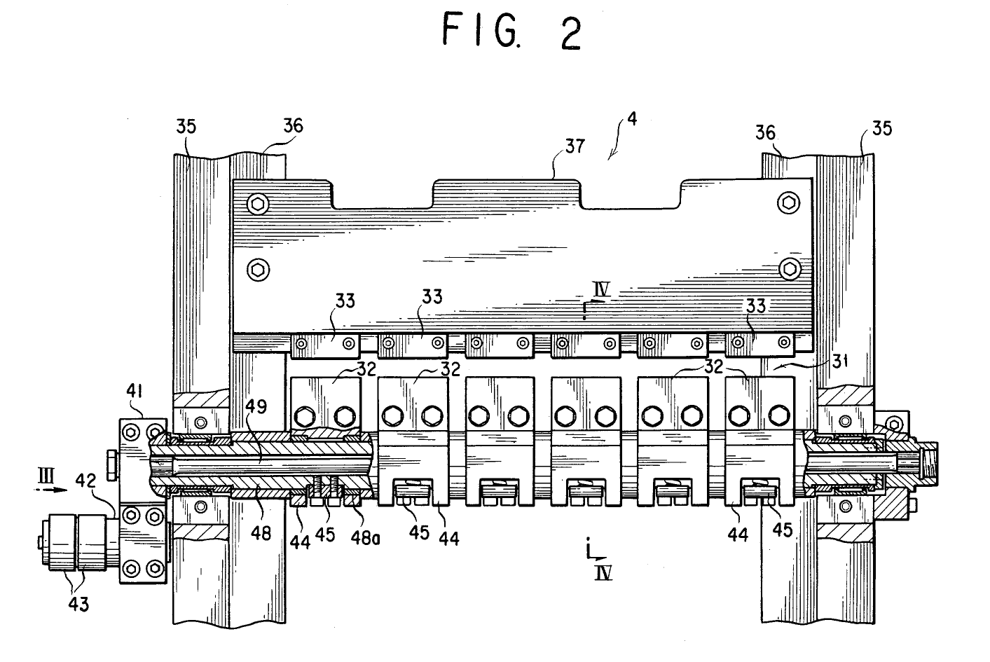

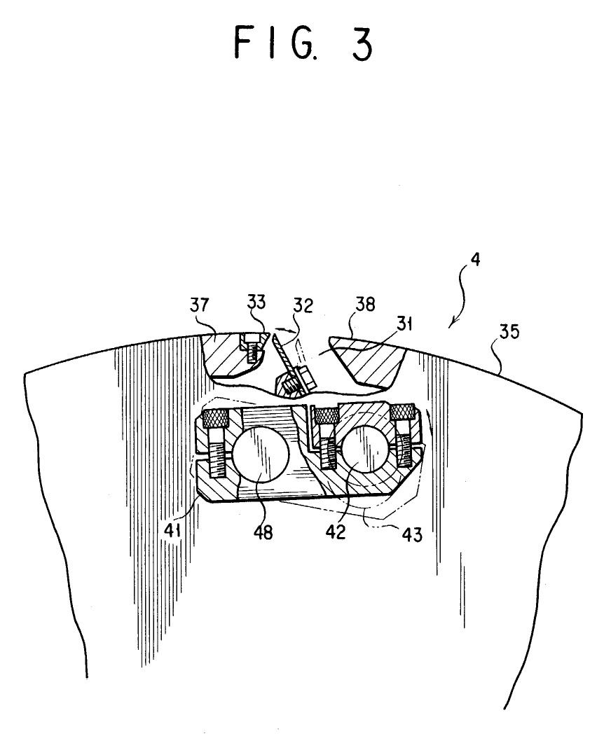

As illustrated fragmentarily but on an enlarged scale in FIG. 2, the jaw cylinder 4 comprises a pair of outer end discs 35, a pair of inner end discs 36 and a core, not shown, upon which both outer end disc pair 35 and inner end disc pair 36 are mounted for independent bidirectional angular displacement within limits. Forming the surface of the jaw cylinder 4 are a plurality of ties each having its opposite ends fastened to either of the two pairs of end disks. One tie joining the inner end disc pair 36 is seen at 37 in both FIGS. 2 and 3, and one tie joining the outer end disc pair 35 at 38 in FIG. 3. The ties 37 and 38 are arranged alternately, and each neighboring pair of ties 37 and 38 are spaced from each other to define one of the three jaw cavities 31 which have been set forth in connection with FIG. 1.

Mounted in each jaw cavity 31 are a series of spaced-apart fixed jaw parts 33 which are screwed or otherwise affixed to the edge of the tie 37 bounding one of the pair of opposite longitudinal edges of the jaw cavity. A series of spaced-apart movable jaw parts 32 are supported, in a manner to be detailed presently, by and between the outer end disc pair 35 in opposed relationship one to each fixed jaw part 33. All the series of movable jaw parts 32 are jointly angularly displaceable with the outer end disc pair 35 about the axis of the jaw cylinder 4, and so are all the series of fixed jaw parts 33 with the inner end disc pair 36.

Hereinafter in this specification, for convenience of description, each series of fixed jaw parts will be collectively referred to as fixed jaw, and individually as fixed jaw parts, with use of the same reference numeral 33 in both cases. Each series of movable jaw parts will also be collectively referred to as movable jaw, individually as movable jaw parts, and the same reference numeral 32 will be used in both cases. Thus, in this particular embodiment, the jaw cylinder 4 has three movable jaws 32 and three fixed jaws 33 mounted thereto, with each movable jaw 32 consisting of six movable jaw parts 32, and each fixed jaw 33 consisting of six fixed jaw parts 33.

Since the outer end disc pair 35 and inner end disc pair 36 are independently rotatable as aforesaid around the unshown core of the jaw cylinder 4 within limits, the spacings between all the movable jaws 32 and all the fixed jaws 33 are adjustable to the thickness of the paper sections to be folded, by varying the angular positions of the outer end disc pair 35 and inner end disc pair 36 on the jaw cylinder core. It is understood that this jaw cylinder 4 incorporates a jaw spacing adjustment of any known or suitable make for concurrently turning the outer end disc pair 35 and inner end disk pair 36 in opposite directions by small increments. The jaw spacing adjustment is not shown, however, as it falls outside the purview of the instant invention.

Jaws and Jaw Drive Means

As will be understood from FIG. 2, each series of movable jaw parts 32 are mounted to a jaw carrier shaft 48 via jaw bases 44 for joint pivotal motion into and out of paper section-folding engagement with one associated series of fixed jaw parts 33. The jaw carrier shaft 48 itself is rotatably supported by the pair of outer end discs 35. The series of movable jaw parts 32 are all aligned along the axis of the jaw cylinder 4, and so are the series of fixed jaw parts 33. The paper section WS may therefore be inserted between the two parallel series of jaws 32 and 33 with little or no possibility of hitting them.

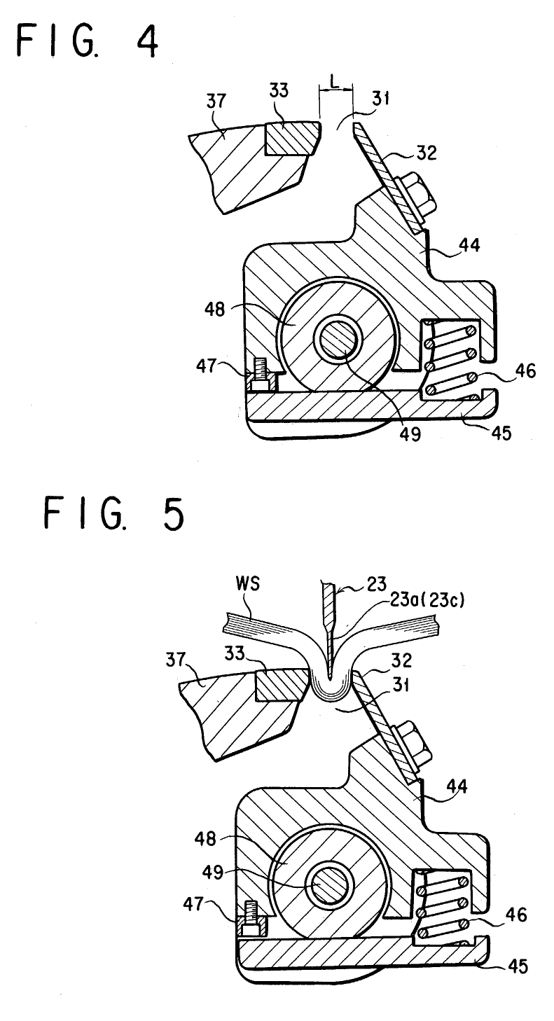

FIGS. 4-6 best illustrate how each movable jaw part 32 is mounted to the jaw carrier shaft 48. Each movable jaw part 32 is fastened or otherwise affixed to one movable jaw base 44 which in turn is rotatably mounted to the jaw carrier shaft 48 via a pair of axially-spaced-apart sleeve bearings seen at 48ₐ in FIG. 2. The movable jaw base 44 is apertured in its part between the pair of sleeve bearings 48ₐ to expose part of the jaw carrier shaft 48. A spring seat 45 is fastened or otherwise secured to the thus-exposed part of the jaw carrier shaft 48 for joint rotation therewith, and a helical compression spring 46 is mounted between movable jaw base 44 and spring seat 45 on one side of the jaw carrier shaft. On the opposite side of the jaw carrier shaft 48, the movable jaw base 44 is biased by the compression spring 46 into abutment against the spring seat 45 via a member 47 of wear-resistant material. As depicted also in FIG. 2, a torsion-bar spring 49 is housed axially in the jaw carrier shaft 48 to bias the same to turn clockwise as viewed in FIGS. 4-6.

The rotation of the jaw carrier shaft 48 in a counterclockwise direction, as viewed in FIGS. 4-6, in opposition to the force of the torsion-bar spring 49 is therefore imparted to each movable jaw base 44 via the spring seat 45 and compression spring 46, causing the associated movable jaw part 32 to turn toward the fixed jaw 33. Upon clockwise rotation of the jaw carrier shaft 48, on the other hand, the spring seat 45 will act directly and rigidly upon the movable jaw base 44 to cause retraction of the movable jaw part 32 away from the fixed jaw 33.

With reference back to FIGS. 2 and 3 the jaw carrier shaft 48 rotatably extends through one of the pair of outer end discs 35 and has a crank arm 41 mounted fast to its projecting end. The crank arm 41 has a crankpin 42 on which a pair of cam follower rollers 43 are rotatably mounted for rolling engagement in a groove in a jaw drive cam, not shown, of annular shape. The cam follower rollers 43 are urged by the torsion-bar spring 49 against the contoured surface defining the groove in the unshown jaw drive cam which is immovably mounted to one of the pair of confronting framing wall 6, FIG. 1.

Thus, with the rotation of the jaw cylinder 4, the cam follower rollers 43 will roll along the groove delineated by the jaw drive cam, thereby causing the crank arm 41 to turn bidirectionally. The bidirectional turn of the crank arm 41 will be imparted directly to the jaw carrier shaft 48 and thence, as has been set forth in conjunction with FIGS. 4-6, to the movable jaw parts 32 via the movable jaw bases 44, spring seats 45 and compression springs 46. When the movable jaw 32 is fully turned toward the fixed jaw 33, the compression springs 46 will be compressed to variable degrees depending upon the thickness of the folded midpart of the paper section WS caught therebetween together with the folding blade 23. The variable degrees of compression of the compression springs 46 will determine variable amounts of energy thereby stored for acting on the respective movable jaw parts 32 in order to cause the same to press the paper section WS against the fixed jaw 33.

Folding Blades

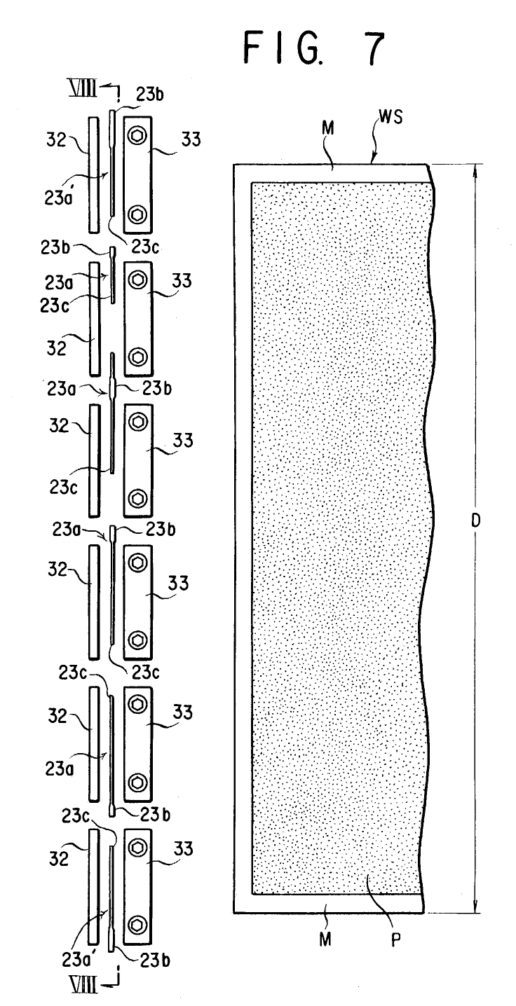

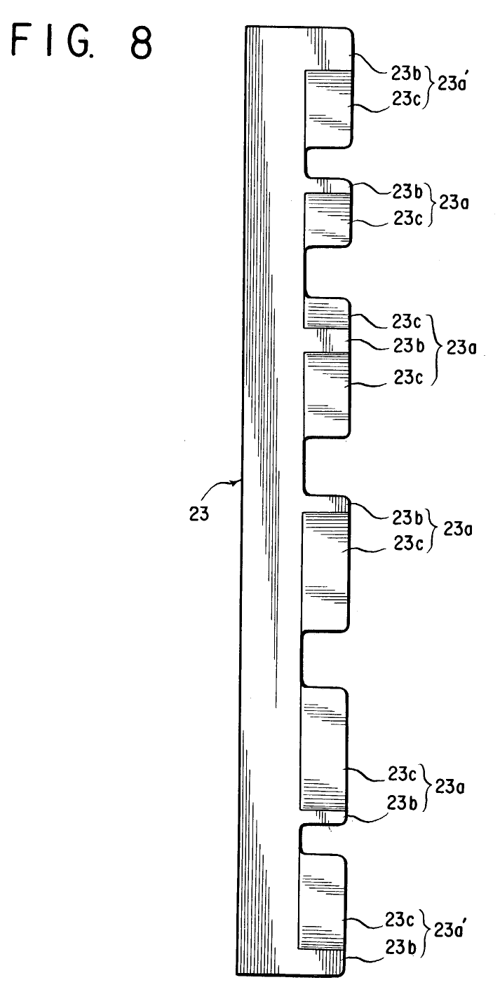

Reference may be had mostly to FIGS. 7 and 8 for the following study of the folding blades 23 on the FIG. 1 folding cylinder 3. Each folding blade 23 is in the form of a slender strip of sheet metal extending parallel to the axis of the folding cylinder 3 and therefore to that of the jaw cylinder 4. Greater in its longitudinal dimension than the width D of each paper section WS, the folding blade 23 is arranged on the folding cylinder 3 to have a pair of opposite end portions extending beyond the pair of opposite sides of the paper section WS as in FIG. 7, The folding blade 23 has its folding edge, shown directed to the right in FIG. 8, divided into a series of folding blade parts 23ₐ. These folding blade parts are spaced apart from each other an enough distance for them to travel radially of the folding cylinder 3 clear of bridges, not shown, extending across the slot in the surface of the folding cylinder through which the folding blade is to go into and out of one of the jaw cavities 31 in the jaw cylinder 4. Of the six folding blade parts shown here, the two outmost ones which have the noted portions projecting laterally beyond the opposite sides of the paper section WS have their reference characters primed by way of contradistinction from the other, medially situated folding blade parts 23a which are to push only the image area P of the paper section.

It will be further observed from FIG. 7 in particular that the folding blade parts 23ₐ and 23ₐ are each not of constant thickness, each having a portion 23_{b} that is thicker than the rest 23_{c}. The arrangement of the thick portions 23_{b} and thin portions 23_{c} of the folding blade parts 23ₐ and 23ₐ is determined according to the novel concepts of this invention in order to avert ink transfer between the contacting surfaces of the paper section WS without lessening the mechanical strength of the folding blades 23 to any inconvenient degree, as set forth in detail hereinbelow.

Positioned in register, circumferentially of the jaw cylinder 4, with the image area P of each paper section WS, the medial folding blade parts 23ₐ have each at least one thick portion 23_{b} which is out of register with both movable jaw parts 32 and fixed jaw parts 33. The thin portions 23_{c} of these medial folding blade parts 23ₐ are all in register with both movable jaw parts 32 and fixed jaw parts 33. The two outmost folding blade parts 23ₐ have thick portions 23_{b} which, although placed in register with both outmost movable jaw parts 32 and outmost fixed jaw parts 33, are both out of register with the paper section WS or at least with its image area P. In any event, depending upon the relative dimensions of the folding blade 23, jaws 32 and 33, and paper section WS axially of the jaw cylinder 4, the two outmost folding blade parts 23ₐ should have thick portions 23_{b} that are out of register with at least either of the image area P of the paper section and the opposed jaw parts 32 and 33.

The thick portions 23_{b} of both medial folding blade parts 23ₐ and outmost folding blade parts 23ₐ must be thick enough to keep these folding blade parts from bending, buckling, breaking, or suffering other damage when they push the paper sections into the jaw cavities or withdraw from between the closed jaws 32 and 33. The thin portions 23_{c}, on the other hand, must be thin enough to prevent ink offset between the contacting surfaces of the paper sections when they are caught between the jaws 32 and 33.

A preferred material for the folding blade 23 is a sheet of titanium-base alloy or like high-strength metal. Fabricated from such material, the thin portions 23_{c} of the folding blade parts 23ₐ and 23ₐ can be from about ⅕ to about 3/20 times as thick as the thick portions 23_{b}. Experiment has proved that, for the best results, the folding blade 23 inclusive of the thick portions 23_{b} of the folding blade parts 23ₐ and 23ₐ should be from about 0.5 to about 2.0 millimeters thick, and their thin portions 23_{c} from about 0.1 to about 0.3 millimeters thick.

Operation

The capital L in FIG. 4 denotes the minimum spacing between movable jaw 32 and fixed jaw 33, that is, the spacing between the jaws when the movable jaw is fully turned toward the fixed jaw. Preparatory to the commencement of printing press operation, this minimum jaw spacing L should be determined according to the thickness of each folded paper section, so as to eliminate the likelihood of the paper section accidentally falling off the jaws. Then the web of paper W printed may be threaded through the folding device as indicated in FIG. 1.

As the printing press is set into operation, the cutting cylinder 2, folding cylinder 3, jaw cylinder 4 and delivery fan 5 will all rotate at the same peripheral speed. Traveling over the folding cylinder 3, the printed web W will be cut into successive sections WS by the cutting blades 11 on the cutting cylinder 2 in cooperation with the anvils 22 on the folding cylinder.

In a position angularly spaced half a revolution of the folding cylinder 3 from where the web W is cut as above, each paper section WS will have its midpart placed opposite one of the jaw cavities 31 in the jaw cylinder 4. One of the folding blades 23 on the folding cylinder 3 will then push this midpart of the paper section WS into the jaw cavity 31. Thereupon the movable jaw 32 mounted in this jaw cavity will turn from the phantom position of FIG. 3 to that indicated by the solid lines in the same figure, engaging the inserted midpart of the paper section WS against the fixed jaw 33 together with the folding blade 23. The movable jaw 32 will be so actuated as the crank arm 41 on the jaw carrier shaft 48 is caused to turn counterclockwise in FIG. 3 by the unshown jaw drive cam with which the cam follower rollers 43 on the crankpin 42 travel in constant rolling engagement with the rotation of the jaw cylinder 4. The jaw carrier shaft 48 will turn with the crank arm 41 against the force of the torsion-bar spring 49 built into it.

As will be understood by referring to FIGS. 4-6 again, the counter-clockwise rotation of the jaw carrier shaft 48 will be imparted to the movable jaw parts 32 via the spring seats 45, compression springs 46 and jaw bases 44. The movable jaw parts 32 will thus resiliently press the midpart of the paper section WS against the fixed jaw 33 as the compression springs 46 undergo compression to variable degrees determined by the total thickness of the doubled midpart of the paper section WS and the folding blade 23, the latter being still caught in the former.

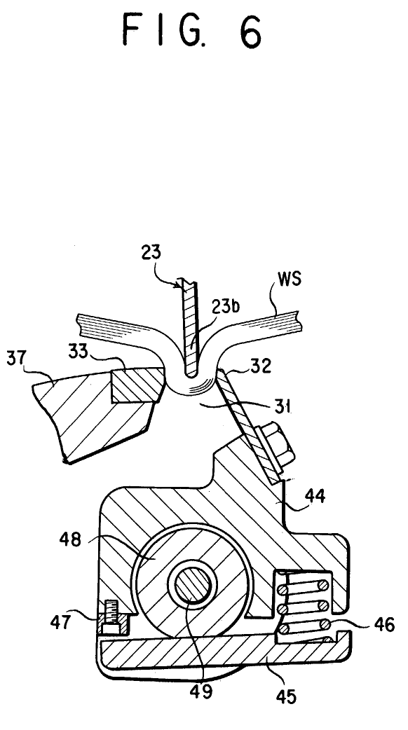

FIG. 5 shows the thin portion 23, of the folding blade part 23, caught between the jaws 32 and 33 together with the folded midpart of the paper section WS. FIG. 6 is a similar illustration showing the thick portion 23_{b} of one of the outmost folding blade part 23ₐ. It will be seen that the compression spring 46 is compressed more in FIG. 6 than in FIG. 5, exerting a greater force upon the paper section WS. The force exerted at this time by each movable jaw part 12 on the paper section FS is proportional to the extent to which the associated compression spring 16 was compressed when that movable jaw part was turned toward the fixed jaw 33. In other words, the thicker is the part of the folding blade that is caught between each associated pair of movable jaw part 32 and fixed jaw part 33, the greater will be the force exerted by that movable jaw on the paper section WS.

A reference to FIG. 7 again will reveal that only the thin portions 23_{c} of the medial folding blade parts 23ₐ are caught between those jaw parts 32 and 33 which are in register with the image area P of the paper section WS. The thin portions 23_{c} of the outmost folding blade parts 23ₐ are also in register with the image area P of the paper section WS. These thin portions 23_{c} of the folding blade parts 23ₐ and 23ₐ are so thin that the paper section WS has its doubled midpart captured between the jaws 32 and 33 with a force that is just a little more than the minimum required to prevent the paper section from accidental disengagement after the withdrawal of the folding blade. The thick portions 23_{b} of all the medial folding blade parts 23ₐ are all disposed out of register with both movable jaw parts 32 and fixed jaw parts 33. Although the thick portions 23_{c} of the two outmost folding blade parts 23ₐ lie between the outmost movable and fixed jaw parts 32 and 33, they are out of register with the paper section WS or at least with its image area P.

Thus, even when the paper section WS is engaged between the jaws 32 and 33 together with the folding blade 23, no such pressure is to be applied to its image area P as to cause ink offset between its contacting surfaces. The required mechanical strength of each folding blade part 23ₐ or 23ₐ is nevertheless maintained by providing the thick portion 23_{b} for each folding blade part. It will be appreciated that the thin portions 23_{c} of the folding blade parts 23ₐ and 23ₐ can be made much thinner than in the absence of the thick portions 23_{b} without significantly sacrificing the strength of each folding blade part.

Immediately after the engagement of the midpart of the paper section WS between the jaws 32 and 33, the folding blade 23 will withdraw out of the jaw cavity 31 in the jaw cylinder and retract into the folding cylinder, leaving behind the doubled midpart of the paper section. Then the movable jaw 32 will be urged by the compression springs 46 to press the midpart of the paper section WS more closely against the fixed jaw 33 and hence to fold the same along its centerline.

The insertion of the midpart of one paper section WS by one folding blade 23 on the folding cylinder 3 into one jaw cavity 31 in the jaw cylinder 4, and the engagement of the inserted midpart of the paper section between one associated pair of jaws 32 and 33, will be repeated with each one third of a revolution of these cylinders 3 and 4. With the continued rotation of the folding cylinder 3 and jaw cylinder 4 in opposite directions, the paper section WS will be folded as its leading half is placed upon the trailing half on the jaw cylinder.

The paper section WS will ride over the jaw cylinder 4 approximately two thirds of a revolution thereof. Then the crank arm 41 on the jaw carrier shaft 48 will turn clockwise, as viewed in FIG. 3, under the influence of the unshown jaw drive cam with which the cam follower rollers 43 are traveling in constant engagement during the rotation of the jaw cylinder 4. The torsion-bar spring 49 will assist such clockwise turn of the jaw carrier shaft 48. Driven positively by the jaw carrier shaft 48, instead of via the compression springs 46 as in the case of counterclockwise turn, the movable jaw 32 will release the folded paper section WS and so allow the same to fall by gravity off the surface of the jaw cylinder 4 into one of the pockets defined by the slanting vanes 8, FIG. 1, on the delivery fan 5. This delivery fan is in constant rotation in a clockwise direction as viewed in FIG. 1. The vanes 8 are so angled with respect to this rotational direction of the delivery fan 5 that the folded paper section WS will subsequently slide down the vane onto the underlying delivery conveyor system 7 thereby to be transported to a place of shipment.

Conclusion

Notwithstanding the foregoing detailed disclosure it is not desired that the present invention be limited by the exact showing of the appended drawings or by the description thereof. For example, the division of the folding blade 23 into the series of spaced-apart parts 23ₐ will be unnecessary if the folding cylinder 3 has no bridges across the slot in which the folding blade is mounted. A continuous folding blade may then be employed which has thick portions out of register with the jaw parts 32 and 33 or which, provided that it is strong enough mechanically, is uniformly thin except for its opposite end portions that are out of register with the image area of the paper section.

These and other obvious modifications and alterations of the illustrated embodiment are intended in the foregoing disclosure. It is therefore appropriate that the invention be construed broadly and in a manner consistent with the fair meaning or proper scope of the claims which follow.

What is claimed is:

1. In a folding device to be appended to a web-fed printing press, wherein a printed paper web is cut into sections by a cutting cylinder while traveling on a folding cylinder, wherein each paper section has its midpart subsequently pushed off the folding cylinder into a jaw cavity in a jaw cylinder, and wherein each paper section is subsequently carried away from the folding cylinder onto the jaw cylinder to be folded into a signature, the improvement comprising:
(a) a fixed jaw immovably mounted in the jaw cavity in the jaw cylinder and extending parallel to the axis of the jaw cylinder;
(b) a movable jaw mounted in the jaw cavity in the jaw cylinder and extending parallel to the axis of the jaw cylinder, the movable jaw being movable relative to the jaw cylinder toward and away from the fixed jaw in order to engage and fold each paper section as its midpart is inserted in the jaw cavity;
(c) at least either of the fixed and the movable jaw being divided into a series of spaced-apart jaw parts; and
(d) a folding blade mounted to the folding cylinder for pushing the midpart of each paper section into space between the fixed and the movable jaw in the jaw cavity in the jaw cylinder, the folding blade having portions that are thicker than the rest of the folding blade and which are out of register with at least either of an image area of each paper section being pushed into the jaw cavity and said at least either of the fixed and the movable jaw.

2. In a folding device to be appended to a web-fed printing press, wherein a printed paper web is cut into sections by a cutting cylinder while traveling on a folding cylinder, wherein each paper section has its midpart subsequently pushed off the folding cylinder into a jaw cavity in a jaw cylinder, and wherein each paper section is subsequently carried away from the folding cylinder onto the jaw cylinder to be folded into a signature, the improvement comprising:
(a) a series of spaced-apart fixed jaw parts mounted in the jaw cavity in the jaw cylinder and extending parallel to the axis of the jaw cylinder over a distance not less than the dimension of each paper, section in the axial direction of the jaw cylinder;
(b) a series of spaced-apart movable jaw parts mounted in the jaw cavity in the jaw cylinder and extending parallel to the axis of the jaw cylinder over a distance approximately the same as the series of fixed jaw parts, the series of movable jaw parts being jointly movable relative to the jaw cylinder toward and away from the series of fixed jaw parts in order to engage and fold each paper section as its midpart is inserted in the jaw cavity;
(c) the series of movable jaw parts being opposed one to each of the series of fixed jaw parts; and
(d) a folding blade mounted to the folding cylinder for pushing the midpart of each paper section into space between the series of fixed and movable jaw parts in the jaw cavity in the jaw cylinder, the folding blade having portions that are thicker than the rest of the folding blade and which are out of register with at least either of an image area of each paper section being pushed into the jaw cavity and both of the fixed and the movable jaw parts.

3. The folding device of claim 2 wherein the folding blade is divided into a series of spaced-apart folding blade parts each having at least one of the thicker portions.

4. The folding device of claim 2 wherein the folding blade is of sheet metal and wherein the thicker portions of the folding blade are from about five to about seven times as thick as the rest of the folding blade.

5. The folding device of claim 4 wherein the thicker portions of the folding blade are from about 0.5 to about 2.0 millimeters in thickness, and wherein the rest of the folding blade is from about 0.1 to about 0.3 millimeters in thickness.

6. In a folding device to be appended to a web-fed printing press, wherein a printed paper web is cut into sections by a cutting cylinder while traveling on a folding cylinder, wherein each paper section has its midpart subsequently pushed off the folding cylinder into a jaw cavity in a jaw cylinder, and wherein each paper section is subsequently carried away from the folding cylinder onto the jaw cylinder to be folded into a signature, the improvement comprising:
(a) a series of spaced-apart fixed jaw parts mounted in the jaw cavity in the jaw cylinder and extending parallel to the axis of the jaw cylinder over a distance not less than the dimension of each paper section in the axial direction of the jaw cylinder;
(b) a series of spaced-apart movable jaw parts mounted in the jaw cavity in the jaw cylinder for joint movement toward and away from the series of fixed jaw parts in order to engage and fold each paper section as its midpart is inserted in the jaw cavity;
(c) the series of movable jaw parts being opposed one to each of the series of fixed jaw parts; and
(d) a series of spaced-apart folding blade parts mounted to the folding cylinder for pushing the midpart of each paper section into space between the series of fixed and movable jaw parts in the jaw cavity in the jaw cylinder, each folding blade part having a portion that is situated out of register with both of the fixed and the movable jaw parts and which is thicker than the rest of the folding blade part.

7. The folding device of claim 6 wherein the series of folding blade parts include a plurality of medial folding blade parts each having the thicker portion situated out of register with both of the fixed and the movable jaw parts, and a pair of outmost folding blade parts lying outwardly of the medial folding blade parts, each outmost folding blade part having a portion that is out of register with an image area of each paper section and which is thicker than the rest of the outmost folding blade part.

8. The folding device of claim 6 or 7 wherein the series of folding blade parts are of sheet metal and wherein the thicker portion of each folding blade part is from about five to about seven times as thick as the rest of the folding blade part.

9. The folding device of claim 8 wherein the thicker portion of each folding blade part is from about 0.5 to about 2.0 millimeters in thickness, and wherein the rest of each folding blade part is from about 0.1 to about 0.3 millimeters in thickness.
